(19) United States
(12) Patent Application Publication
(10) Pub. No.: US 2010/0114479 A1
(43) Pub. Date: May 6, 2010

(54) POSITION INFORMATION DETECTING APPARATUS, POSITION INFORMATION DETECTING METHOD, POSITION INFORMATION DETECTING PROGRAM AND STORAGE MEDIUM

(75) Inventor: Takashi Hashimoto, Yokohama (JP)

Correspondence Address: YOUNG & THOMPSON, 209 Madison Street, Suite 500, Alexandria, VA, 22314, US

(73) Assignees: PIONEER CORPORATION, TOKYO (JP); INCREMENT P CORPORATION, TOKYO (JP)

(21) Appl. No.: 12/531,893

(22) PCT Filed: Mar. 26, 2007
(86) PCT No.: PCT/JP2007/056237

§ 371 Date: Sep. 18, 2009

(51) Int. Cl. G01C 21/00

(52) U.S. Cl. 701/207

(57) ABSTRACT

The position information detecting apparatus obtains pinpoint information which coincides with the first address part of the inputted address information, and thereafter detects the pinpoint information which coincides with the second address part inputted. If the position information detecting apparatus can detect the pinpoint information, it determines the position information included in the detected pinpoint information as the detection-object position information. If the position information detecting apparatus cannot detect the pinpoint information, it searches for the range information which coincides with the first address part of the inputted address information. Then, the position information detecting apparatus estimates the position information corresponding to the inputted address information by using the searched range information and the searched pinpoint information.

### TECHNICAL FIELD

The present invention relates to a method of detecting position information corresponding to an address.

### BACKGROUND TECHNIQUE

Conventionally, there is known a navigation apparatus which estimates a position of a facility corresponding to a range of a lot number, by using an address range data associating a link with a range of lot numbers along the link (For example, see. Patent Reference-1).

Patent Reference-1: Japanese Patent Application Laid-open under No. 2006-214965

### DISCLOSURE OF INVENTION

### Problem to be Solved by the Invention

However, in the above navigation apparatus, the estimated facility position may include an error when the lot numbers of the address range data are not equally allocated.

The above is an example of the problem to be solved by the present invention. It is an object of this invention to provide a position information detecting apparatus capable of detecting the position information corresponding to an address with high accuracy.

### Means for Solving the Problem

According to the invention of claim 1, a position information detecting apparatus includes: a pinpoint information storing means which stores pinpoint information including address information including a first address part and a second address part, and position information corresponding to the address information; a range information storing means which stores range information including range information of the address information and position information corresponding to the range information of the address information; a pinpoint information searching means which searches the pinpoint information storing means for the pinpoint information including the first address part which coincides with the first address part of inputted address information; a pinpoint information detecting means which detects the pinpoint information including the second address part which coincides with the second address part of the inputted address information; a range information searching means which searches the range information storing means for the range information including the first address part which coincides with the first address part of the inputted address information; an estimated position information calculating means which calculates estimated position information by estimating the position information corresponding to the inputted address information, by using the range information searched by the range information searching means and the pinpoint information searched by the pinpoint information searching means; and a detection-object position information determining means which determines the position information of the pinpoint information as a detection-object position information when the pinpoint information detecting means detects the pinpoint information, and determines the estimated position information calculated by the estimated position information calculating means as the detection-object position information when the pinpoint information detecting means does not detect the pinpoint information.

According to the invention of claim 3, a position information detecting method includes: a pinpoint information storing process which stores pinpoint information including address information including a first address part and a second address part, and position information corresponding to the address information; a range information storing process which stores range information including range information of the address information and position information corresponding to the range information of the address information; a pinpoint information searching process which searches the pinpoint information storing process for the pinpoint information including the first address part which coincides with the first address part of inputted address information; a pinpoint information detecting process which detects the pinpoint information including the second address part which coincides with the second address part of the inputted address information; a range information searching process which searches the range information storing process for the range information including the first address part which coincides with the first address part of the inputted address information; an estimated position information calculating process which calculates estimated position information by estimating the position information corresponding to the inputted address information, by using the range information searched by the range information searching process and the pinpoint information searched by the pinpoint information searching process; and a detection-object position information determining process which determines the position information of the pinpoint information as a detection-object position information when the pinpoint information detecting process detects the pinpoint information, and determines the estimated position information calculated by the estimated position information calculating process as the detection-object position information when the pinpoint information detecting process does not detect the pinpoint information.

According to the invention of claim 4, a position information detecting program executed by an apparatus includes a computer, the program makes the computer to function as: a pinpoint information storing means which stores pinpoint information including address information including a first address part and a second address part, and position information corresponding to the address information; a range information storing means which stores range information including range information of the address information and position information corresponding to the range information of the address information; a pinpoint information searching means which searches the pinpoint information storing means for the pinpoint information including the first address part which coincides with the first address part of inputted address information; a pinpoint information detecting means which detects the pinpoint information including the second address part which coincides with the second address part of the inputted address information; a range information searching means which searches the range information storing means for the range information including the first address part which coincides with the first address part of the inputted address information; an estimated position information calculating means which calculates estimated position information by estimating the position information corresponding to the inputted address information, by using the range information searched by the range information searching means and the pinpoint information searched by the pinpoint information searching means; and a detection-object position information determining means which determines the position information of the pinpoint information as a detection-object position information when the pinpoint information detecting means detects the pinpoint information, and determines the estimated position information calculated by the estimated position information calculating means as the detection-object position information when the pinpoint information detecting means does not detect the pinpoint information.

### BRIEF DESCRIPTION OF THE DRAWINGS

FIG. 1 is a conceptual diagram of a navigation apparatus according to an embodiment;

FIG. 2 is a block diagram showing a schematic configuration of a position information detecting apparatus;

FIG. 3 is a conceptual diagram of data structure of a pinpoint information DB;

FIG. 4 is a conceptual diagram of data structure of a range information DB;

FIGS. 5A and 5B show examples of dividing the range information;

FIGS. 6A and 6B show effects in a case that the position is estimated by using divided range information;

FIG. 7 is a flowchart showing a position information detecting process; and

FIG. 8 is a flowchart showing a position information detecting process (range information division).

### BRIEF DESCRIPTION OF REFERENCE NUMBERS

101 Pinpoint information searching unit

102 Pinpoint information detecting unit

103 Range information searching unit

104 Estimated position information calculating unit

105 Detection-object position information determining unit

106 Map searching unit

120 Pinpoint information DB

140 Range information DB

200 Navigation apparatus

300 Position information detecting apparatus

### DETAILED DESCRIPTION OF THE PREFERRED EMBODIMENTS

According to one aspect of the present invention, there is provided a position information detecting apparatus including: a pinpoint information storing means which stores pinpoint information including address information including a first address part and a second address part, and position information corresponding to the address information; a range information storing means which stores range information including range information of the address information and position information corresponding to the range information of the address information; a pinpoint information searching means which searches the pinpoint information storing means for the pinpoint information including the first address part which coincides with the first address part of inputted address information; a pinpoint information detecting means which detects the pinpoint information including the second address part which coincides with the second address part of the inputted address information; a range information searching means which searches the range information storing means for the range information including the first address part which coincides with the first address part of the inputted address information; an estimated position information calculating means which calculates estimated position information by estimating the position information corresponding to the inputted address information, by using the range information searched by the range information searching means and the pinpoint information searched by the pinpoint information searching means; and a detection-object position information determining means which determines the position information of the pinpoint information as a detection-object position information when the pinpoint information detecting means detects the pinpoint information, and determines the estimated position information calculated by the estimated position information calculating means as the detection-object position information when the pinpoint information detecting means does not detect the pinpoint information.

The above position information detecting apparatus is specifically applicable to a car navigation apparatus and a personal computer. The position information detecting apparatus stores the pinpoint information and the range information, in advance. The pinpoint information includes address information including a first address part (city name and street name) and a second address part (house number), and position information corresponding to the address information (latitude and longitude information). The range information includes the range information of the address information, and the position information corresponding to the range information of the address information.

The position information detecting apparatus obtains the pinpoint information which coincides with the first address part of the inputted address information, from the pinpoint information storing means, and thereafter detects the pinpoint information which coincides with the inputted second address information. If the position information detecting apparatus can detect the pinpoint information, it determines the position information included in the detected pinpoint information as the detection-object position information. If the position information detecting apparatus cannot detect the pinpoint information, it searches for the range information which coincides with the first address part of the inputted address information. Then, the position information detecting apparatus estimates the position information corresponding to the inputted address information by using the searched range information and the searched pinpoint information.

As described above, the position information detecting apparatus determines the position information of the pinpoint information as the detection-object position information if the pinpoint information coinciding with the inputted address information exists, and estimates the inputted position information by using the pinpoint information coinciding with the first address part of the inputted address information and the range information coinciding with the first address part of the inputted address information if the pinpoint information coinciding with the inputted address information does not exist.

Therefore, since the position information detecting apparatus estimates the position of the inputted address information from the range information including the inputted information in the address range, by using the pinpoint information storing the position information corresponding to the address information, the estimation accuracy of the position information can be improved, in comparison with the case in which the position of the inputted address information is estimated by using only the range information.

According to one feature of the above position information detecting apparatus, the estimated position information calculating means generates divided range information by dividing the range information searched by the range information searching means by using the pinpoint information searched by the pinpoint information searching means, and calculates the estimated position information based on the divided range information. In this case, by dividing the existing range information by using the pinpoint information, the position information detecting apparatus narrows the address range of the existing range information (the range of the house numbers). Therefore, if the inputted position information is estimated by using the divided range information, the detection accuracy of the position information can be improved, in comparison with the case in which the position information is estimated by the existing range information.

According to another aspect of the present invention, there is provided a position information detecting method including: a pinpoint information storing process which stores pinpoint information including address information including a first address part and a second address part, and position information corresponding to the address information; a range information storing process which stores range information including range information of the address information and position information corresponding to the range information of the address information; a pinpoint information searching process which searches the pinpoint information storing process for the pinpoint information including the first address part which coincides with the first address part of inputted address information; a pinpoint information detecting process which detects the pinpoint information including the second address part which coincides with the second address part of the inputted address information; a range information searching process which searches the range information storing process for the range information including the first address part which coincides with the first address part of the inputted address information; an estimated position information calculating process which calculates estimated position information by estimating the position information corresponding to the inputted address information, by using the range information searched by the range information searching process and the pinpoint information searched by the pinpoint information searching process; and a detection-object position information determining process which determines the position information of the pinpoint information as a detection-object position information when the pinpoint information detecting process detects the pinpoint information, and determines the estimated position information calculated by the estimated position information calculating process as the detection-object position information when the pinpoint information detecting process does not detect the pinpoint information.

In this method, since the position of the inputted address information is estimated from the range information including the inputted information in the address range, by using the pinpoint information storing the position information corresponding to the address information, the estimation accuracy of the position information can be improved, in comparison with the case in which the position of the inputted address information is estimated by using only the range information.

According to still another aspect of the present invention, there is provided a position information detecting program executed by an apparatus including a computer, the program makes the computer to function as: a pinpoint information storing means which stores pinpoint information including address information including a first address part and a second address part, and position information corresponding to the address information; a range information storing means which stores range information including range information of the address information and position information corresponding to the range information of the address information; a pinpoint information searching means which searches the pinpoint information storing means for the pinpoint information including the first address part which coincides with the first address part of inputted address information; a pinpoint information detecting means which detects the pinpoint information including the second address part which coincides with the second address part of the inputted address information; a range information searching means which searches the range information storing means for the range information including the first address part which coincides with the first address part of the inputted address information; an estimated position information calculating means which calculates estimated position information by estimating the position information corresponding to the inputted address information, by using the range information searched by the range information searching means and the pinpoint information searched by the pinpoint information searching means; and a detection-object position information determining means which determines the position information of the pinpoint information as a detection-object position information when the pinpoint information detecting means detects the pinpoint information, and determines the estimated position information calculated by the estimated position information calculating means as the detection-object position information when the pinpoint information detecting means does not detect the pinpoint information.

By executing the program on various apparatuses, the position information detecting apparatus according to the present invention can be realized. The position information detecting program can preferably be handled in a stated recorded on a storage medium.

### Embodiment

Now, a description will be given of a preferred embodiment of the present invention with reference to attached drawings. The following explanation shows such an example that the present invention is applied to an on-vehicle navigation apparatus.

[Navigation Apparatus]

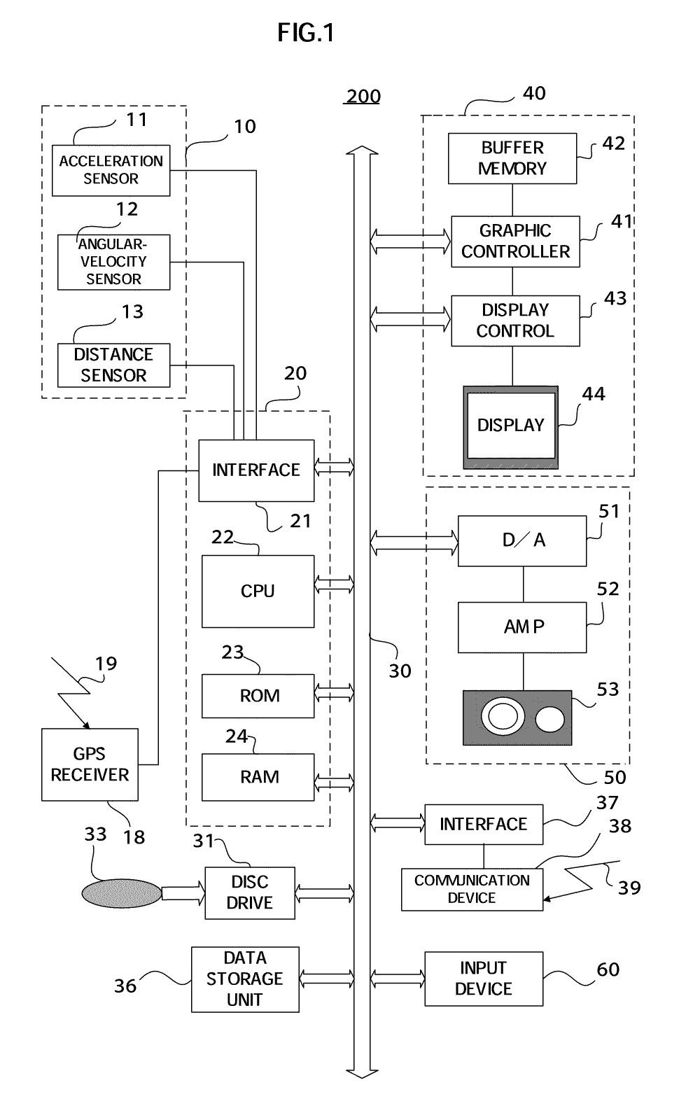

FIG. 1 shows a configuration of a navigation apparatus 200 according to an embodiment of the present invention. As shown in FIG. 1, the navigation apparatus 200 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for transmitting downlink data including position measurement data from plural GPS satellites. The position measurement data is used for detecting the absolute position of the vehicle from longitude and latitude information.

The system controller 20 includes an interface 21, a CPU 22, a ROM 23 and a RAM 24, and controls the entire navigation apparatus 200.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map data and facility data.

The communication device 38 includes an FM tuner, a beacon receiver, a mobile phone and a dedicated communication card, for example, and obtains various information via the communication interface 37.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A conversion of the sound digital data transmitted from the disc drive 31 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 44 is a touch panel system, a touch panel provided on the display screen of the display 44 functions as the input device 60, too.

[Position Information Detecting Apparatus]

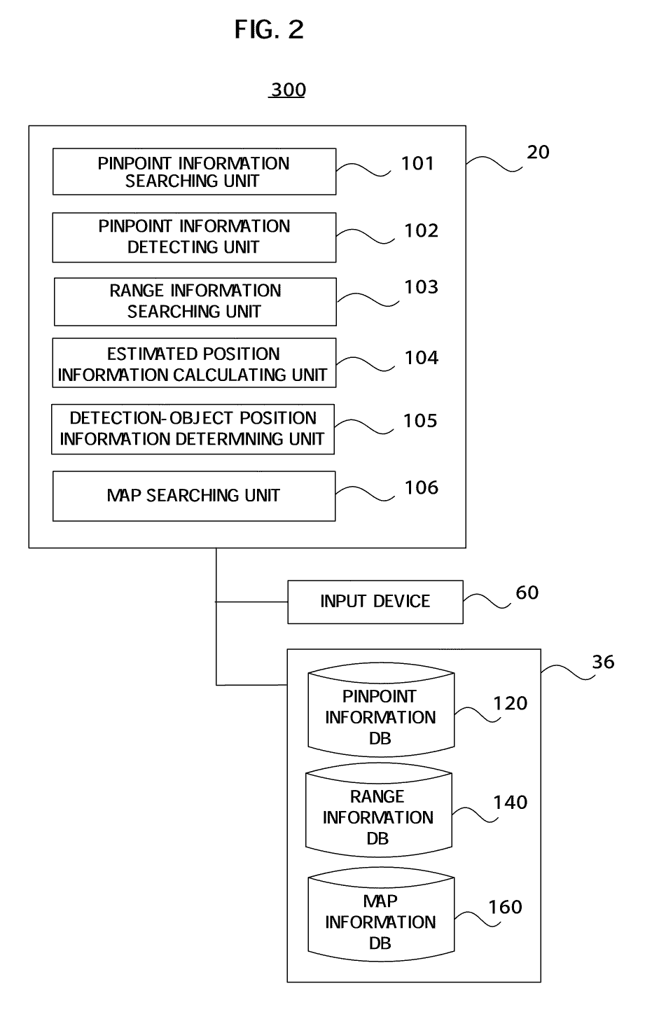

FIG. 2 shows a functional configuration of a position information detecting apparatus 300. Substantially, the position information detecting apparatus 300 is formed by the constitutional elements of the navigation apparatus 200. As shown, the position information detecting apparatus 300 includes the system controller 20, the data storage unit 36 and the input unit 60. The data storage unit 36 includes a pinpoint information DB 120, a range information DB 140 and a map information DB 160. The system controller 120 includes a pinpoint information searching unit 101, a pinpoint information detecting unit 102, a range information searching unit 103, an estimated position information calculating unit 104, a detection-object position information determining unit 105 and a map searching unit 106. Namely, by executing a predetermined program, the system controller 20 realizes the pinpoint information searching unit 101, the pinpoint information detecting unit 102, the range information searching unit 103, the estimated position information calculating unit 104, the detection-object position information determining unit 105 and the map searching unit 106.

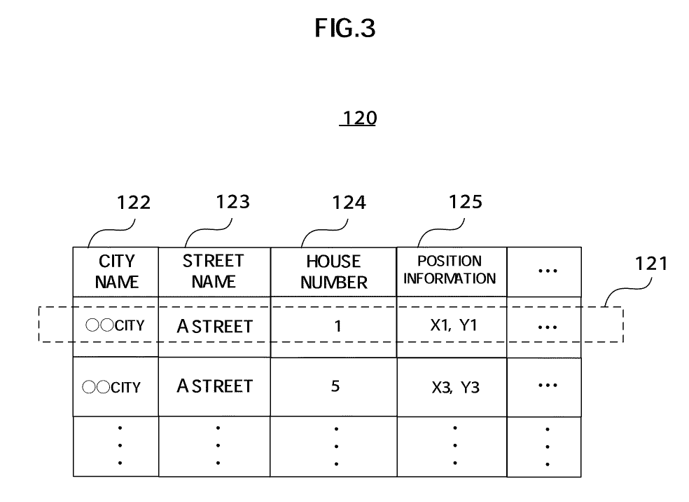

The pinpoint information DB 120 is a database storing pinpoint information 121. FIG. 3 shows an example of the pinpoint information DB 120. The pinpoint information 121 is information including a city name 122, a street name 123, a house number 124 and a position information (latitude and longitude information) 125 corresponding to address information. It is noted that, in this embodiment, the word “address information” includes the city name, the street name and the house number.

If the position information detecting apparatus 300 can search the pinpoint information 121 that coincides with the inputted address information, it can obtain the position information of the inputted address information.

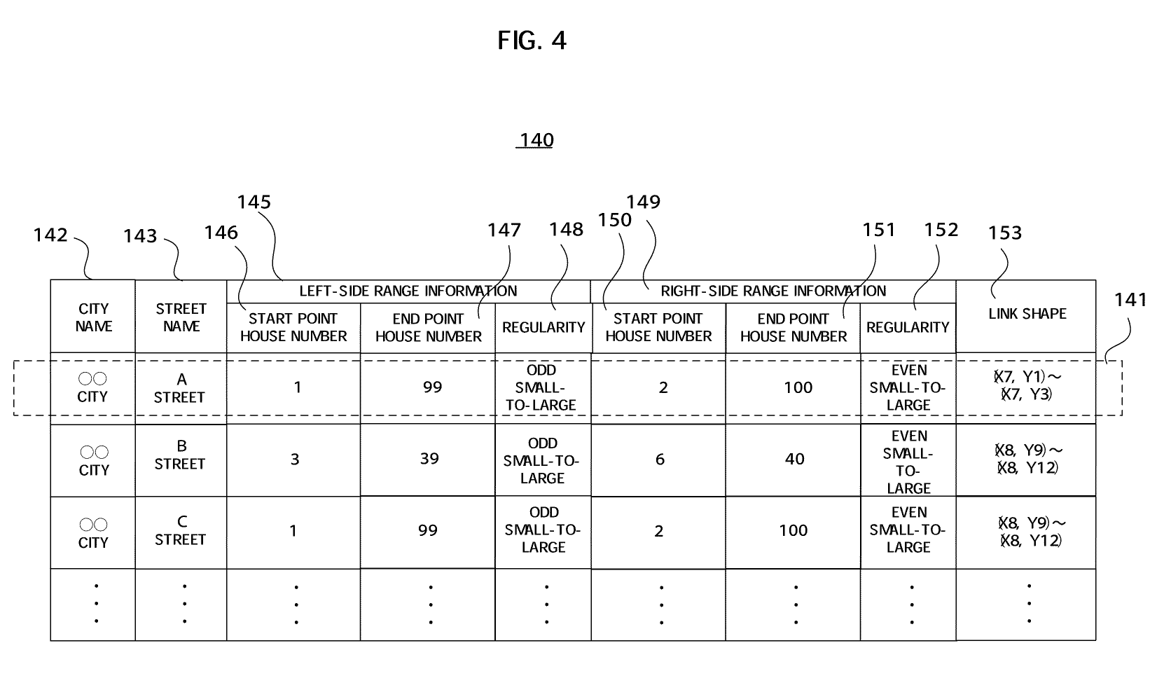

The range information DB 140 is a database storing the range information 141 which is position information corresponding to a predetermined address range. The range information 141 is set to every link. The “link” is latitude and longitude vector data sequence indicating the shape of a road segment. An example of the range information DB 140 is shown in FIG. 4.

As shown, the range information 141 includes a city name 142, a street name 143, left-side range information 145, right-side range information 149 and a link shape 153. The left-side range information 145 includes a left-side start point house number 146 and a left-side endpoint house number 147 and a left-side regularity 148. The right-side range information 149 includes a right-side start point house number 150, a right-side endpoint house number 151 and a right-side regularity 152.

The left-side range information 145 relates to the house numbers on the left side of the road corresponding to the link. The left-side house number corresponding to the start point of the link is set to the left-side start point house number 146, and the left-side house number corresponding to the end point of the link is set to the left-side end point house number 147. The regularity (for example, odd number, even number, small-to-large order, etc.) of the arrangement order of the left-side house numbers is set to the left-side regularity 148.

The right-side range information 149 relates to the house numbers on the right side of the road corresponding to the link. The right-side house number corresponding to the start point of the link is set to the right-side start point house number 150, and the right-side house number corresponding to the end point of the link is set to the right-side end point house number 151. The regularity of the arrangement order of the right-side house numbers is set to the right-side regularity 152.

The link shape 153 includes the position information (latitude and longitude) of the start point and the end point of the link. If the link has an interpolating point, the link shape 153 includes the position information of the interpolating point.

In this embodiment, the information including the city name 142, the street name 143, the left-side range information 145 and the right-side range information 149 is referred to as “the range information of the address information” of the range information 141.

The pinpoint information searching unit 101 searches the pinpoint information DB 120 for the pinpoint information 121 having the city name and the street name (hereinafter, the city name and the street name is referred to as “first address part”) coinciding with the first address part of the address information inputted by the input device 60.

The pinpoint information detecting unit 102 detects the pinpoint information 121 including the house number 124 coinciding with the house number of the inputted address information (hereinafter, the house number is referred to as “second address part”), from the pinpoint information 121 searched by the pinpoint information searching unit 101.

The range information searching unit 103 searches the range information DB 140 for the range information 141 having the first address part coinciding with the first address part of the inputted address information.

The estimated position information calculating unit 104 estimates the position information corresponding to the inputted address information by using the range information 141 searched by the range information searching unit 103. The methods of estimating the position information corresponding to the inputted address information includes: a method of using only the range information 141 in which the range information of the address information includes the inputted address information, and another method of using the range information 141 (hereinafter referred to as “divided range information”) divided by using the pinpoint information 121 searched by the pinpoint information searching unit 101 and the range information 141 in which the range information of the address information includes the inputted address information. The estimated position information calculating unit 104 estimates the position information corresponding to the inputted address information on the premise that the positions from the start point house number to the end point house number in the range information 141 are equally allocated.

The detection-object position information determining unit 105 determines the position information of the pinpoint information 121 as the detection-object position information when the pinpoint information detecting unit 102 detects the pinpoint information 121 having the address information coinciding with the inputted address information, and determines the estimated position information calculated by the estimated position information calculating unit 104 as the detection-object position information when the pinpoint information detecting unit 102 does not detect the pinpoint information 121 having the address information coinciding with the inputted address information.

The map searching unit 106 performs the map search, by using the map information DB 160, for the detection-object position information determined by the detection-object position information determining unit 105.

The pinpoint information DB 120 in this embodiment functions as the pinpoint information storing means, and the range information DB 140 functions as the range information storing means.

[Division of Range Information]

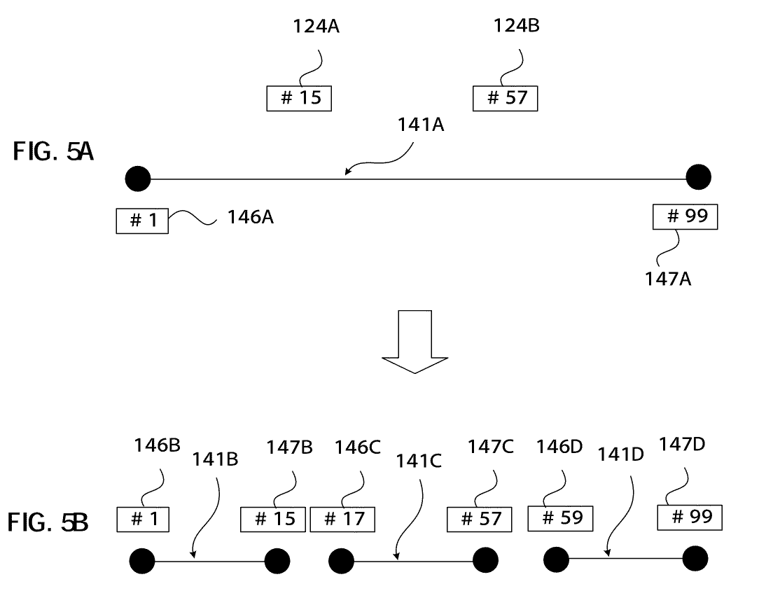

Next, the division of the range information 141 will be described with reference to FIGS. 5A and 5B.

The division of the range information 141 is to generate two range information 141 by using the pinpoint information 121 as the border, when there exists a pinpoint information 121 having the house number 124 coinciding with the house number included in the left-side range information 145 or the right-side range information 149 of the range information 141 searched by the range information searching unit 102.

First, it is assumed that the range information searching unit 103 is searching for the range information 141A in which the left-side start point house number 146A is “1”, the left-side end point house number 147A is “99”, the left-side regularity 148A includes “Odd number” and “small-to-large”, as shown in FIG. 5A.

In addition, it is assumed that the pinpoint information searching unit 101 searches the pinpoint information 121A whose the house number 124A is “15” and the pinpoint information 121B whose house number 124B is “57”.

In this case, the house number 124A of the pinpoint information 121A and the house number 124B of the pinpoint information 121B are located between the left-side start point house number 146 and the left-side end point house number 147 in the left-side range information 145 of the range information 141A, and therefore the estimated position information calculating unit 104 divides the range information 141A by using the house number 124A and the house number 124B.

As shown in FIG. 5B, the estimated position information calculating unit 104 divides the range information 141A into the divided range information 141B, the divided range information 141C and the divided range information 141D. The divided range information 141B has the left-side start point house number 146B of “1” and the left-side end point house number 147B of “15”. The divided range information 141C has the left-side start point house number 146C of “17” and the left-side end point house number 147C of “57”. The divided range information 141D has the left-side start point house number 146D of “59” and the left-side end point house number 147D of “99”.

The estimated position information calculating unit 104 calculates the position information of the left-side start point house number 146C by using the link shape 153 and the position information 125 of the pinpoint information 121. Specifically, the estimated position information calculating unit 104 calculates the distance from the position of the left-side start point house number 146B to the position of the left-side end point house number 147B, thereafter calculates the distance of one segment (for example, from the house number “1” to “3”, etc.), and determines the position one segment remote from the left-side end point house number 147B along the link shape 153 of the range information 141A as the position of the left-side start point house number 146C.

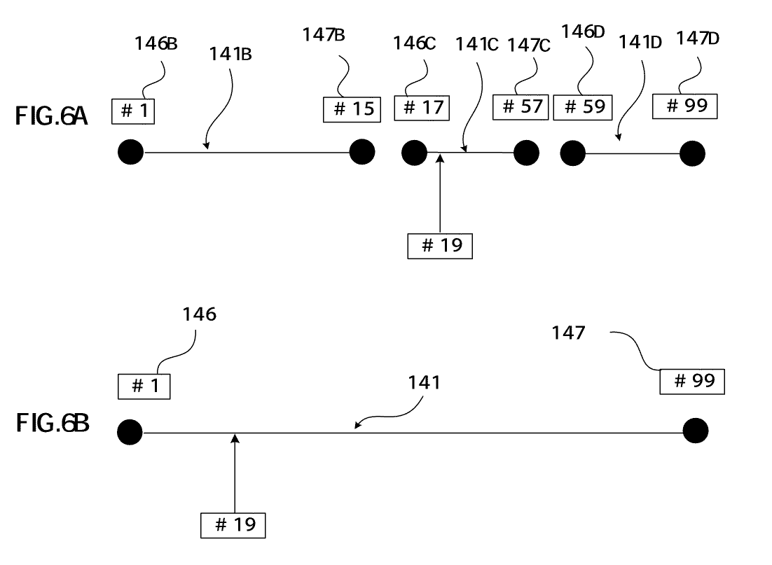

In a case that the positions from the left-side start point house number 146A of “1” to the left-side end point house number 147A of “99” are not equally spaced, that the space for one segment from the house number “1” to the house number “15” is longer than other spaces, and that the house number of the inputted address information is “19”, as shown in FIG. 6A, the estimated position information calculating unit 104 determines the position which is remote from the start point house number “17” in the divided range information 141C by the one segment of the divided range information 141C as the estimated position.

It is noted that, if the estimated position information calculating unit 104 does not generate the divided range information 141, the position of the house number “19” of the inputted address information is estimated as the position indicated by FIG. 6B.

In this case, since the positions from the left-side start point house number 146A of “1” to the left-side end point house number 147A of “99” are not equally spaced, a larger error takes place.

However, even if the house numbers are not equally allocated, if the estimated position calculating unit 104 divides the range information 141 by using the pinpoint information 121, the range of the house numbers of the left-side range information 145 of the divided range information 141 is narrowed, and the error between the estimated position and the actual position can be reduced.

[Position Information Detecting Process]

Next, “the position information detecting process” according to this embodiment will be described.

In the position information detecting process according to this embodiment, the position information detecting apparatus 300 detects the position information corresponding to the inputted address information by using the pinpoint information 121 and the range information 141.

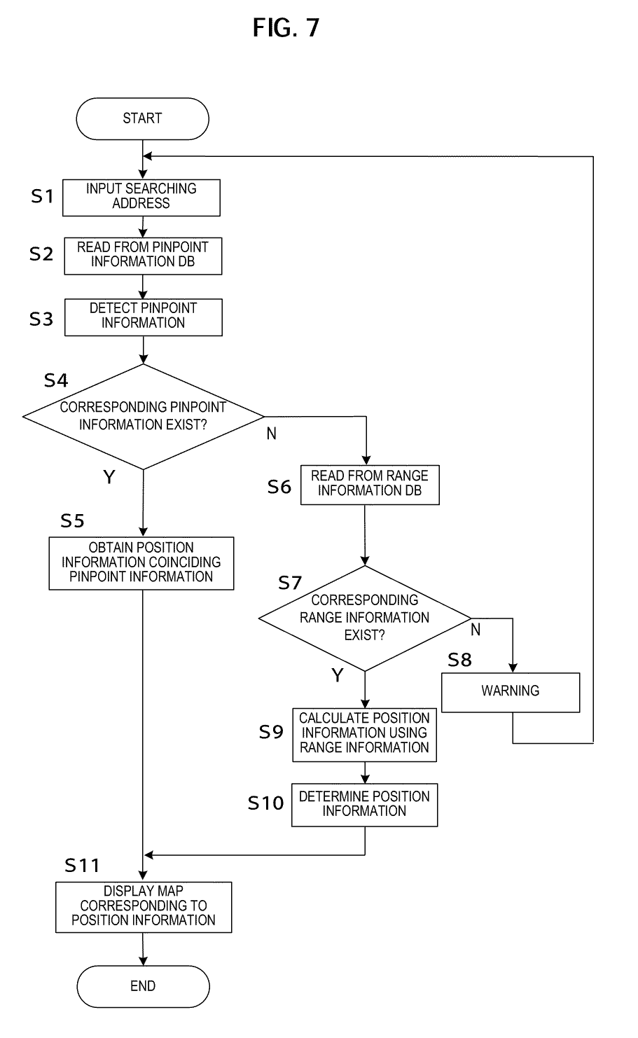

FIG. 7 shows a flowchart of the position information detecting process according to this embodiment. This process is realized by the system controller 20 in the position information detecting apparatus 300, which executes a program prepared in advance.

First, when the system controller 20 detects that a user inputs an address by the input operation and instructs the address search (step S1), the pinpoint information searching unit 101 searches the pinpoint information DB 120 for the pinpoint information 121 which coincides with the first address part of the inputted address information inputted via the input device 60 (step S2).

Then, the pinpoint information detecting unit 102 detects the pinpoint information 121 having the second address part which coincides with the second address part of the inputted address information, from the pinpoint information 121 searches by the pinpoint information searching unit 101 (step S3).

When the pinpoint information detecting unit 102 detects the pinpoint information 121 having the second address part which coincides with the second address part of the inputted address information (step S4; Yes), the detection-object position information determining unit 105 determines the position information 125 of the pinpoint information 121 detected by the pinpoint information detecting unit 102 as the position information of the detection-object (step S5).

On the other hand, when the pinpoint information detecting unit 102 does not detect the pinpoint information 121 having the second address part which coincides with the second address part of the inputted address information (step S4; No), the range information searching unit 103 searches the range information DB 140 for the range information having the first address part which coincides with the first address part of the inputted address information (step S6).

When the range information 141 searched by the range information searching unit 103 does not include the range information 141 including the inputted address information in the range information of the address information (step S7; No), it means that the position information corresponding to the inputted address information cannot be determined. Therefore, the system controller 20 performs the warning requesting the user to input again (step S8).

On the other hand, when the range information 141 searched by the range information searching unit 103 includes the range information 141 including the inputted address information in the range information of the address information (step S7; Yes), the estimated position information calculating unit 104 determines the start point house number and the end point house number of the range information 141 including the inputted address information in the range information of the address information as the positions of the both end points of the link shape 153, and determines the position information corresponding to the second address part of the inputted address information in a case that the house numbers between the start point house number and the endpoint house number are arranged in an equally-spaced manner along the link shape 153 as the estimated position information (step S9).

The detection-object position information determining unit 105 determines the estimated position information calculated by the estimated position information calculating unit 104 as the position information of the detection-object (step S10).

The map searching unit 106 searches the map based on the position information determined by the detection-object position information determining unit 105, and the displays the search result (step S11). Thus, the system controller 20 ends the process.

As described above, the position information detecting apparatus 300 can specify the position information corresponding to the inputted address information, without estimating the position using the range information 141, if it can search the pinpoint information 121 having the address information coinciding with the inputted address information. Also, if there is no pinpoint information 121 having the address information coinciding with the inputted address information, the position information detecting apparatus 300 estimates the position of the inputted address information by using the range information 141.

[Position Information Detecting Process (Range Information Division)]

Next, the position information detecting process (range information division) according to this embodiment will be described.

In the position information detecting process (range information division), the position information detecting apparatus 300 detects the position information corresponding to the inputted address information by using the divided range information 141.

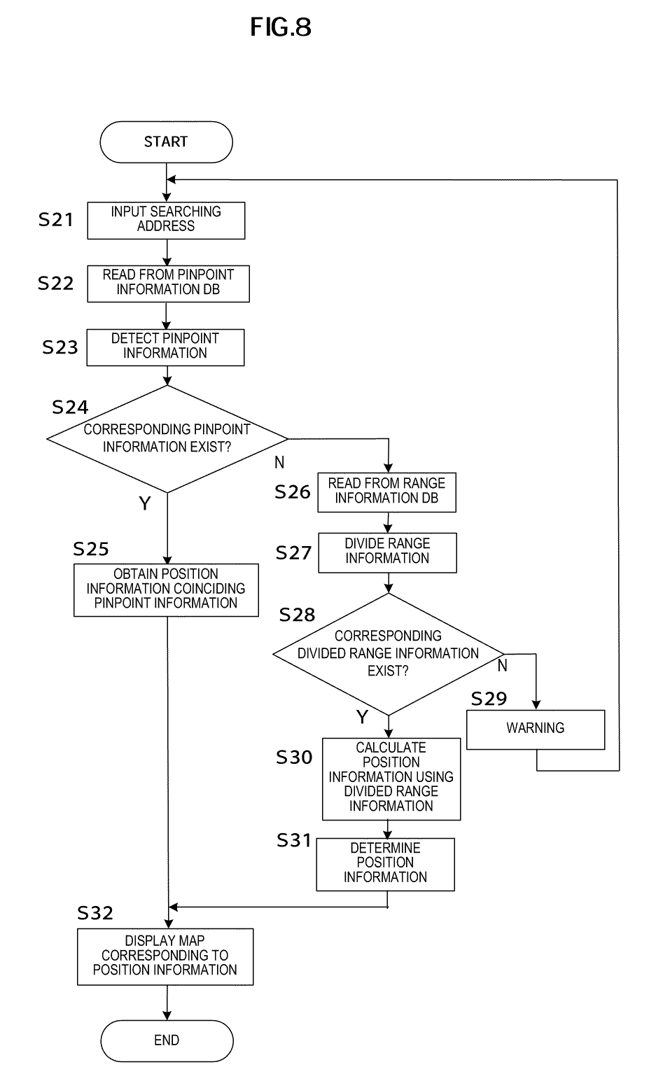

FIG. 8 shows a flowchart of the position information detecting process (range information division) according to this embodiment. This process is realized by the system controller 300 in the position information detecting apparatus 300, which executes a program prepared in advance.

First, when the system controller 20 detects that a user inputs an address by the input operation and instructs the address search (step S21), the pinpoint information searching unit 101 searches the pinpoint information DB 120 for the pinpoint information 121 which coincides with the first address part of the inputted address information inputted via the input device 60 (step S22).

Then, the pinpoint information detecting unit 102 detects the pinpoint information 121 having the second address part which coincides with the second address part of the inputted address information, from the pinpoint information 121 searched by the pinpoint information searching unit 101 (step S23).

When the pinpoint information detecting unit 102 detects the pinpoint information 121 having the second address part which coincides with the second address part of the inputted address information (step S24; Yes), the detection-object position information determining unit 105 determines the position information 125 of the pinpoint information 121 detected by the pinpoint information detecting unit 102 as the position information of the detection-object (step S25).

On the other hand, when the pinpoint information detecting unit 102 does not detect the pinpoint information 121 having the second address part which coincides with the second address part of the inputted address information (step S24; No), the range information searching unit 103 searches the range information DB 140 for the range information having the first address part which coincides with the first address part of the inputted address information (step S26).

The estimated position information calculating unit 104 divides the range information 141 searched by the range information searching unit 103 by using the pinpoint information 121 searched by the pinpoint information searching unit 101 (step S27).

Here, if there is no divided range information 141 including the inputted address information in the range information of the address information (step S28; No), it means that the position information corresponding to the inputted address information cannot be determined. Therefore, the system controller 20 performs the warning requesting the user to input again (step S29).

On the other hand, when the divided range information 141 includes the divided range information 141 including the inputted address information in the range information of the address information (step S28; Yes), the estimated position information calculating unit 104 determines the start point house number and the end point house number of the divided range information 141 including the inputted address information in the range information of the address information as the positions of the both endpoints of the link shape 153, and determines the position information corresponding to the second address part of the inputted address information in a case that the house numbers between the start point house number and the end point house number are arranged in an equally-spaced manner along the link shape 153 as the estimated position information (step S30).

The detection-object position information determining unit 105 determines the estimated position information calculated by the estimated position information calculating unit 104 as the position information of the detection-object (step S31).

The map searching unit 106 searches the map based on the position information determined by the detection-object position information determining unit 105, and the displays the search result (step S32). Thus, the system controller 20 ends the process.

As described above, if there is no pinpoint information 121 having the address information coinciding with the inputted address information, the position information detecting apparatus 300 generates the divided range information by using the pinpoint information 121 and the range information 141, and estimates the position by using the divided range information 141. Thereby, the position information detecting apparatus 300 narrows range of the house numbers of the range information 141. The position information detecting apparatus can improve the detection accuracy of the position information by estimating the inputted position information by using the divided range information 141, in comparison with the case in which the position information is estimated by using non-divided range information 141.

As described above, the position information detecting apparatus 300 includes: a pinpoint information storing means which stores pinpoint information including address information including a first address part and a second address part, and position information corresponding to the address information; a range information storing means which stores range information including range information of the address information and position information corresponding to the range information of the address information; a pinpoint information searching means which searches the pinpoint information storing means for the pinpoint information including the first address part which coincides with the first address part of inputted address information; a pinpoint information detecting means which detects the pinpoint information including the second address part which coincides with the second address part of the inputted address information; a range information searching means which searches the range information storing means for the range information including the first address part which coincides with the first address part of the inputted address information; an estimated position information calculating means which calculates estimated position information by estimating the position information corresponding to the inputted address information, by using the range information searched by the range information searching means and the pinpoint information searched by the pinpoint information searching means; and a detection-object position information determining means which determines the position information of the pinpoint information as a detection-object position information when the pinpoint information detecting means detects the pinpoint information, and determines the estimated position information calculated by the estimated position information calculating means as the detection-object position information when the pinpoint information detecting means does not detect the pinpoint information.

As described above, the position information detecting apparatus determines the position information of the pinpoint information as the detection-object position information if the pinpoint information coinciding with the inputted address information exists, and estimates the inputted position information by using the pinpoint information coinciding with the first address part of the inputted address information and the range information coinciding with the first address part of the inputted address information if the pinpoint information coinciding with the inputted address information does not exist.

Therefore, since the position information detecting apparatus estimates the position of the inputted address information from the range information including the inputted information in the address range, by using the pinpoint information storing the position information corresponding to the address information, the estimation accuracy of the position information can be improved, in comparison with the case in which the position of the inputted address information is estimated by using only the range information.

### Other Embodiments

In the above embodiment, the position information detecting apparatus 300 is applied to the navigation apparatus 200. However, the present invention is not limited to this embodiment, and may be applied to various apparatuses such as a personal computer.

In the above embodiment, the position information 125 in the pinpoint information 121 is the latitude and longitude information. However, the present invention is not limited to this embodiment. The position information 125 may include three information, i.e., “link shape”, “position on the link” and “left/right information”. The “link shape” has the same meaning as the link shape 153 in the range information 141. The “position on the link” indicates the position on the link by the percentage, wherein the start point and the end point of the vector data sequence of the “link shape” is expressed by “0%” and “100%”, respectively. The method of determining the “position on the link” is to draw a vertical line with respect to the nearby link from the latitude and longitude position of the facility to determine the cross point as the position on the link. Since the navigation apparatus has an aim to guide to the road near the facility, the above expression is effective. The “left/right” information designates whether the corresponding facility is located on the left or right side of the link.

In the above position information detecting process and the position information detecting process (range information division), the detection of the position information is performed after all the “city name”, the “street” and the “house number” are inputted by the user, the present invention is not limited to this embodiment. In an example, the input of the city name can be omitted to specify the position for all the cases in which the street and the house number coincide, and then the input of the city name may be requested thereafter.

The above embodiment is applied to the address information including the city name, the street and the house number, the present invention is not limited to this embodiment, and may be applied to the address information of other format. For example, if the object area of the navigation apparatus 200 is broad, plural cities having the same city name may exist. In this case, an area name broader than the city may be designated to specify the city. In an actual example, the city “Detroit” exists in the state of Michigan and the state of Illinois in the United States. In this case, the “state” maybe designated. As another example, the post-code may be used in place of the city name.

In the above embodiment, the estimated position information calculating unit 104 generates the divided range information 141 by using the pinpoint information 121, and estimates the position information of the inputted address information by using the divided range information 141. However, the present invention is not limited to this, and the position information of the inputted address may be estimated by using the pinpoint information 121 and the range information 141.

In the above embodiment, in the position information detecting process (range information division), the estimated position information calculating unit 104 detects the divided range information 141 including the inputted address information in the range information of the address information, after dividing the range information 141. However, the present invention is not limited to this. The range information 141 may be divided after the range information 141 including the inputted address information in the range information of the address information is detected.

In the above embodiment, the estimated position information calculating unit 104 in the position information detecting apparatus 300 generates the divided range information 141 by dividing the range information 141 by using the pinpoint information 121, and estimates the position information corresponding to the inputted address information by using the divided range information 141. However, the present invention is not limited to this embodiment. The divided range information 141, divided in advance by using the pinpoint information 121, may be prepared in the range information DB 140, and the estimated position information calculating unit 104 may estimate the position information corresponding to the inputted address information by using the divided range information 141.

### INDUSTRIAL APPLICABILITY

This invention can be used for an apparatus which detects the position information corresponding to the address information.

1-5. (canceled)

6. A position information detecting apparatus comprising:
a pinpoint information storing means which stores pinpoint information including address information including a first address part and a second address part, and position information corresponding to the address information;
a range information storing means which stores range information including range information of the address information and position information corresponding to the range information of the address information;
a pinpoint information searching means which searches the pinpoint information storing means for the pinpoint information including the first address part which coincides with the first address part of inputted address information;
a pinpoint information detecting means which detects the pinpoint information including the second address part which coincides with the second address part of the inputted address information;
a range information searching means which searches the range information storing means for the range information including the first address part which coincides with the first address part of the inputted address information;
an estimated position information calculating means which generates divided range information by dividing the range information searched by the range information searching means by using the pinpoint information searched by the pinpoint information searching means, and calculates estimated position information based on the divided range information by estimating the position information corresponding to the inputted address information; and
a detection-object position information determining means which determines the position information of the pinpoint information as a detection-object position information when the pinpoint information detecting means detects the pinpoint information, and determines the estimated position information calculated by the estimated position information calculating means as the detection-object position information when the pinpoint information detecting means does not detect the pinpoint information.

7. A position information detecting method comprising:
a pinpoint information storing process which stores, into a pinpoint information storing unit, pinpoint information including address information including a first address part and a second address part, and position information corresponding to the address information;
a range information storing process which stores, into a range information storing unit, range information including range information of the address information and position information corresponding to the range information of the address information;
a pinpoint information searching process which searches the pinpoint information storing unit for the pinpoint information including the first address part which coincides with the first address part of inputted address information;
a pinpoint information detecting process which detects the pinpoint information including the second address part which coincides with the second address part of the inputted address information;
a range information searching process which searches the range information storing unit for the range information including the first address part which coincides with the first address part of the inputted address information;
an estimated position information calculating process which generates divided range information by dividing the range information searched by the range information searching process by using the pinpoint information searched by the pinpoint information searching process, and calculates estimated position information based on the divided range information by estimating the position information corresponding to the inputted address information; and
a detection-object position information determining process which determines the position information of the pinpoint information as a detection-object position information when the pinpoint information detecting process detects the pinpoint information, and determines the estimated position information calculated by the estimated position information calculating process as the detection-object position information when the pinpoint information detecting process does not detect the pinpoint information.

8. A position information detecting program stored on a computer-readable medium and executed by an apparatus comprising a computer, the program makes the computer to function as:
a pinpoint information storing means which stores pinpoint information including address information including a first address part and a second address part, and position information corresponding to the address information;
a range information storing means which stores range information including range information of the address information and position information corresponding to the range information of the address information;
a pinpoint information searching means which searches the pinpoint information storing means for the pinpoint information including the first address part which coincides with the first address part of inputted address information;
a pinpoint information detecting means which detects the pinpoint information including the second address part which coincides with the second address part of the inputted address information;
a range information searching means which searches the range information storing means for the range information including the first address part which coincides with the first address part of the inputted address information;
an estimated position information calculating means which generates divided range information by dividing the range information searched by the range information searching means by using the pinpoint information searched by the pinpoint information searching means, and calculates estimated position information based on the divided range information by estimating the position information corresponding to the inputted address information; and a detection-object position information determining means which determines the position information of the pinpoint information as a detection-object position information when the pinpoint information detecting means detects the pinpoint information, and determines the estimated position information calculated by the estimated position information calculating means as the detection-object position information when the pinpoint information detecting means does not detect the pinpoint information.
